(19) United States
(12) Patent Application Publication
(10) Pub. No.: US 2011/0163692 A1
(43) Pub. Date: Jul. 7, 2011

(54) Circuit Arrangement and Method for Operating a Light Source

(76) Inventors: Harald Schmitt, Munchen (DE); Arwed Storm, Dachau (DE)

(21) Appl. No.: 12/997,865

(22) PCT Filed: Jun. 13, 2008
(86) PCT No.: PCT/EP08/57466

§ 371 Date: Dec. 13, 2010

(51) Int. Cl. H05B 37/02

(52) U.S. Cl. 315/297

(57) ABSTRACT

A method for operating at least one light source, in which an input voltage (Uᵢₙ) is converted into an AC output voltage, the AC output voltage providing a power for operating at least one light source (5), wherein the frequency of the output voltage is frequency-modulated with a triangular modulation signal if the input voltage (Uᵢₙ) is a DC voltage.

### TECHNICAL FIELD

The invention relates to a circuit arrangement and a method for operating at least one light source, in which an input voltage (Uᵢₙ) is converted into an AC output voltage, the AC output voltage providing a power for operating at least one light source (5).

### PRIOR ART

The invention is based on a method for operating a light source in accordance with the precharacterizing clause of the main claim.

In cost-optimized operating devices for gas discharge lamps, it is conventional to dispense with regulation of the switching frequency of the inverter and to operate said inverter instead at a fixed frequency. This results in problems in terms of electromagnetic compatibility since the switching frequency is emitted over the lamp lines as noise spectrum, which is concentrated, owing to the fixed switching frequency, on very narrow noise bands at the fundamental and at uneven harmonics of the fundamental.

Given an improved design, the switching frequency of the inverter is modulated with an approximately sinusoidal signal, which is derived from the modulation of the AC input voltage. This results in an improved response with respect to electromagnetic compatibility, but the method fails at a DC input voltage, which in turn results in fixed-frequency operation.

### OBJECT

The object of the invention is to specify a method for operating at least one gas discharge lamp, in which an input voltage is converted into an AC output voltage, the AC output voltage providing a power for operating at least one light source (5), and in which the response of the circuit arrangement implementing the method with respect to electromagnetic compatibility is improved in the case of an AC input voltage and in the case of a DC input voltage.

### DESCRIPTION OF THE INVENTION

This object is achieved as regards the method by a method for operating at least one gas discharge lamp, in which an input voltage is converted into an AC output voltage, the AC output voltage providing a power for operating at least one light source (5), and the frequency of the output voltage is modulated with a triangular modulation signal if the input voltage is a DC voltage.

It is advantageous here if the frequency of the output voltage is modulated with a sinusoidal modulation signal if the input voltage is a sinusoidal AC voltage, and the frequency of the modulation signal in the case of a DC input voltage is between 100 Hz and 3 kHz and, in the case of an AC input voltage, is twice the frequency of the AC input voltage. In this case, the phase angle of the modulation signal with respect to the AC input voltage is preferably selected such that the crest factor of the output voltage substantially corresponds to the value \sqrt{2}. This results in a maximum amplitude of the AC input voltage at a maximum frequency of the AC output voltage.

In many cases, the output voltage is subject to amplitude modulation, which originates from insufficient smoothing of the rectified AC input voltage. In order to achieve a light emission which is as uniform as possible, the frequency deviation of the frequency modulation is set such that this amplitude modulation of the output voltage is minimized.

In some cases it is advantageous if the frequency deviation of the frequency modulation is set such that improved electromagnetic compatibility is achieved. It is thus possible to adhere to the valid limit values with respect to electro-magnetic compatibility.

The object as regards the circuit arrangement is achieved by a circuit arrangement for operating at least one light source, with an input for inputting a DC or AC voltage, and an output which is connected to the light source, the circuit arrangement implementing a method according to one or more of the abovementioned features.

In this case, the circuit arrangement contains a power factor correction circuit, which preferably has an identification circuit (12), which identifies whether the input voltage is DC or AC. In order to be able to safely distinguish the voltage which is input at the input, the identification circuit (12) preferably contains a bandpass filter, a high-pass filter or a low-pass filter. However, it can also have an edge detection device instead.

In order to be able to perform the appropriate control and regulation tasks, the circuit arrangement contains a control circuit, which preferably has an integrated module such as an ASIC. Alternatively, the control circuit can also have a microcontroller.

In order to start the lamp, the circuit arrangement preferably has a resonant circuit.

Further advantageous developments and configurations of the invention are given in the remaining dependent claims and in the description below.

### BRIEF DESCRIPTION OF THE DRAWING(S)

The invention will be explained in more detail below with reference to exemplary embodiments. In the drawings:

FIG. 1 shows a flowchart of the method according to the invention.

FIG. 2 shows the block circuit diagram of a circuit arrangement according to the invention with a control circuit having a microcontroller.

FIG. 3 shows the block circuit diagram of a circuit arrangement according to the invention with a control circuit having an ASIC.

### PREFERRED EMBODIMENT OF THE INVENTION

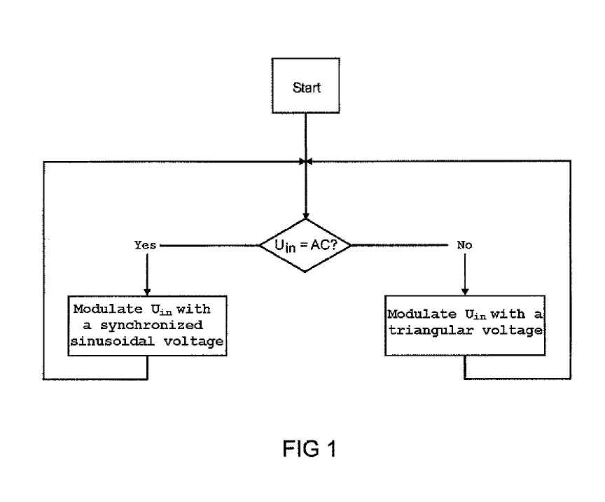

FIG. 1 shows a flowchart of the method according to the invention. After starting, detection is performed to ascertain whether a DC voltage or an AC voltage is present at the input of a circuit arrangement implementing the method according to the invention. The circuit arrangement has an output, which operates at least one gas discharge lamp on an AC output voltage. If a DC voltage is present at the input, the AC output voltage is frequency-modulated with a triangular voltage. The AC output voltage can also be frequency-modulated with a saw-tooth-shaped voltage, however. However, the text which follows always refers to a triangular voltage, but this is explicitly intended to mean a triangular and a saw-tooth-shaped voltage. The frequency of the triangular modulation voltage is in this case between 100 Hz and 3 kHz. If a sinusoidal AC voltage is present at the input, a modulation voltage can be generated from this AC voltage, and this modulation voltage can be used for the frequency modulation of the AC output voltage. The frequency of the modulation voltage is in this case twice the frequency of the AC input voltage. Preferably, in this case the phase angle of the modulation voltage with respect to the AC input voltage is set such that the frequency of the AC output voltage is at its greatest when the instantaneous value of the AC input voltage reaches a maximum.

The frequency deviation of the AC output voltage can in this case be varied in a variety of ways. One possibility is for the amplitude modulation of the AC output voltage, which originates from the insufficient rectification of the AC input voltage, to be compensated as far as possible by a suitable frequency deviation of the superimposed frequency modulation. In principle, this is most successful when the frequency of the AC output voltage is at a maximum given a maximum of the instantaneous value of the AC input voltage, from which a maximum of the instantaneous value of the AC output voltage results. The frequency of the amplitude modulation of the AC output voltage is in principle twice as high as the frequency of the AC input voltage. Since the frequency of the modulation signal is in synchronism with the frequency of the amplitude modulation of the AC output voltage, it follows from this that, at a minimum of the amplitude of the AC output voltage, a minimum of the frequency of the AC output voltage also occurs. The deviation of the frequency modulation can now be set such that the two effects of amplitude modulation and frequency modulation on the output power cancel one another out, with the result that a decidedly uniform power output of the gas discharge lamp is produced, which results in good light quality. The synchronized frequency modulation therefore achieves two aims at the same time: firstly, uniform light output and therefore improved light quality, and secondly a distribution of the interference frequencies over a broad frequency band in order to improve electromagnetic compatibility of the circuit arrangement.

Another possibility for the variation of the frequency deviation is optimization of the electromagnetic compatibility of the circuit arrangement. The greater the frequency deviation, the broader the frequency band on which interference occurs becomes. Given a broader frequency band, the interference is lower per frequency, however, since the frequencies occur less often per unit time. The frequency deviation can therefore be set such that the applicable limit values for the electromagnetic compatibility are safely adhered to.

If, however, a DC voltage is input into the circuit arrangement implementing the method according to the invention, it is not possible to derive an AC modulation signal from this. In order to be able to perform frequency modulation of the AC output voltage even during DC-voltage operation, a triangular modulation signal is produced, by means of which the AC output voltage is frequency-modulated. A triangular signal provides the advantage of uniform distribution of the frequencies of the AC output voltage, with the result that optimum scattering of the interference is achieved. However, it is also conceivable for a signal form to be produced for the modulation signal which results in scattering of the interference in a manner following the corresponding limit value in qualitative terms. In this case, the modulation signal is designed such that the frequencies at which the limit value is high are approached more frequently during the modulation than the frequencies at which the limit value is low. As a result of this method, optimum “utilization” of the existing standards with respect to electromagnetic compatibility is achieved.

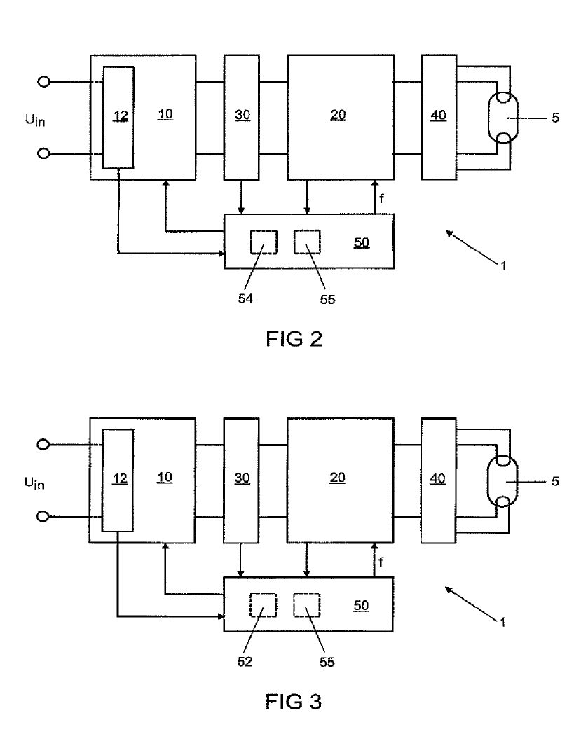

FIG. 2 shows a block circuit diagram of a circuit arrangement according to the invention which implements the method according to the invention. An AC input voltage Uᵢₙ is input into a power factor correction circuit 10. The power factor correction circuit 10 produces from this an amplitude-modulated intermediate-circuit voltage, which is output to a DC voltage intermediate circuit 30. This DC voltage intermediate circuit smooths the modulated DC voltage and inputs it to an inverter 20, which produces an amplitude-modulated and frequency-modulated output voltage Uₒᵤₜ therefrom. This voltage is passed via a resonant circuit 40 and operates a gas discharge lamp 5. The entire circuit arrangement is controlled by a control circuit 50. The control circuit 50 controls and regulates in particular the power factor correction circuit 10 and the inverter 20.

In a first embodiment, the control circuit 50 contains an ASIC 54, which performs the functions of control and regulation. The detection to ascertain whether a DC or AC input voltage Uᵢₙ, is present at the circuit arrangement 1 is in this case performed by an identification circuit 12, which is part of the power factor correction circuit and into which the AC input voltage Uᵢₙ, or the rectified amplitude-modulated AC input voltage Uᵢₙ is input. In the first embodiment, the identification circuit contains a bandpass filter, a high-pass filter or a low-pass filter. The input voltage Uᵢₙ is supplied to said filter and, thereupon, the identification circuit 12 provides an identification signal to the control circuit 50, which then either converts the identification signal into a sinusoidal modulation signal, if Uᵢₙ, is an AC voltage, or produces a triangular modulation signal if Uᵢₙ, is a DC voltage. A fixed-frequency oscillator 55 is modulated with this modulation signal, and the resultant frequency-modulated signal is input to the inverter 20 as the drive signal, said inverter using this signal to drive bridge transistors present in the inverter.

The second embodiment is very similar to the first embodiment and therefore only the differences with respect to the first embodiment will be described. In the second embodiment, the identification circuit contains an edge detection device instead of the bandpass filter, said edge detection device identifying whether Uᵢₙ is a DC or AC voltage. The remaining sequence corresponds to the first embodiment.

FIG. 3 shows a third embodiment of the circuit arrangement 1 according to the invention. The third embodiment is very similar to the first embodiment and therefore only the differences with respect to the first embodiment are described. In the third embodiment, the control circuit 50 contains a microcontroller 52 instead of an ASIC 54. The microcontroller performs the essential control and regulation tasks of the circuit arrangement, as does the ASIC. The identification circuit 12 has a bandpass filter and produces an identification signal, which is input into the control circuit 50. The input signals are digitized via analog-to-digital converters, processed in the microcontroller 52 and output, via digital-to-analog converters, to the power factor correction circuit 10 and the inverter 20. In this case, the frequency modulation takes place with a digital algorithm. The triangular modulation voltage is also produced digitally by means of a table, for example, and then further-processed.

The fourth embodiment is very similar to the third embodiment and therefore only the differences with respect to the third embodiment are described. In the fourth embodiment, the identification circuit contains an edge detection device instead of the bandpass filter, said edge detection device identifying whether Uᵢₙ is a DC or AC voltage. The identification circuit produces the identification signal, which is subjected to analog-to-digital conversion and is then further-processed in the microcontroller. The remaining sequence corresponds to the third embodiment.

1. A method for operating at least one light source, in which an input voltage is converted into an AC output voltage, the AC output voltage providing a power for operating at least one light source, wherein the frequency of the output voltage is frequency-modulated with a triangular modulation signal if the input voltage is a DC voltage.

2. The method as claimed in claim 1, wherein the frequency of the output voltage is frequency-modulated with an AC modulation signal if the input voltage is an AC voltage.

3. The method as claimed in claim 1, wherein the frequency of the triangular modulation signal in the case of a DC input voltage is between 100 Hz and 3 kHz.

4. The method as claimed in claim 1, wherein in the case of an AC input voltage, the frequency of the modulation signal is twice the frequency of the AC input voltage.

5. The method as claimed in claim 3, wherein the phase angle of the modulation signal with respect to the AC input voltage is selected such that the crest factor of the output voltage substantially corresponds to the value \sqrt{2}.

6. The method as claimed in claim 5, wherein the phase angle of the modulation signal is designed such that, at a maximum instantaneous value of the AC input voltage, the maximum frequency of the output voltage is reached.

7. The method as claimed in claim 1, wherein the frequency deviation of the frequency modulation is set such that amplitude modulation of the output voltage resulting from insufficient smoothing of the rectified input voltage is minimized.

8. The method as claimed in claim 1, wherein the frequency deviation of the frequency modulation is set such that improved electromagnetic compatibility is achieved.

9. A circuit arrangement for operating at least one light source, with an input for inputting a DC or AC voltage, and an output which is connected to the light source, wherein the circuit arrangement implements a method as claimed in claim 1.

10. The circuit arrangement as claimed in claim 9, comprising an identification circuit which identifies whether the input voltage is DC or AC.

11. The circuit arrangement as claimed in claim 10, wherein the identification circuit has a bandpass filter, a high-pass filter or a low-pass filter.

12. The circuit arrangement as claimed in claim 10, wherein the identification circuit has an edge detection device.

13. The circuit arrangement as claimed in claim 1, comprising a control circuit, and the control circuit includes an integrated circuit.

14. The circuit arrangement as claimed in claim 1, comprising a control circuit, and the control circuit includes a microcontroller.

15. The circuit arrangement as claimed in claim 1, comprising a resonant circuit.
